(19) United States
(12) Patent Application Publication
(10) Pub. No.: US 2026/0332243 A1
(43) Pub. Date: Oct. 22, 2026

(54) METHODS FOR SI ACCUMULATION IN IOT NTN WITH EXPLICIT AND IMPLICIT EPOCH TIME INDICATION

(71) Applicant: TELEFONAKTIEBOLAGET LM ERICSSON (PUBL), STOCKHOLM (SE)

(72) Inventor: Talha Khan, Santa Clara, CA (US)

(21) Appl. No.: 19/103,512

(22) PCT Filed: Aug. 14, 2023
(86) PCT No.: PCT/US2023/030170

§ 371 Date: Feb. 12, 2025

Related U.S. Application Data
(60) Provisional application No. 63/397,657, filed on Aug. 12, 2022.

(51) Int. Cl. H04B 7/185; H04W 84/06

(52) U.S. Cl. CPC H04B 7/18519; H04W 84/06

(57) ABSTRACT

Methods, systems, and devices are disclosed that facilitate accumulation of NTN SIB. For example, a method performed by a user equipment (UE) for to facilitate non-terrestrial system information block (NTN SIB) accumulation, the method includes determining, based on one or more system information (SI) configuration parameters, whether NTN SIB accumulation should be performed; and performing NTN SIB accumulation when the UE determines NTN SIB accumulation should be performed or not performing NTN SIB accumulation when the UE determines NTN SIB accumulation should not be performed.

### CROSS REFERENCE TO RELATED INFORMATION

This application claims the benefit of United States of America priority application No. 63/397,657 filed on Aug. 12, 2022, titled “METHODS FOR SI ACCUMULATION IN IOT NTN WITH EXPLICIT AND IMPLICIT EPOCH TIME INDICATION.”

### TECHNICAL FIELD

The present disclosure generally relates to the non-terrestrial cellular communication technology.

### BACKGROUND

In 3GPP Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP Release 13, Narrowband Internet of Things (NB-IoT) and LTE-Machine Type Communication (LTE-M) are part of the LTE specifications and provide connectivity to massive machine type communications (mMTC) services.

In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing some parts of the LTE specification, and add needed components. One such component is the introduction of a sophisticated framework for beam forming and beam management to extend the support of the 3GPP technologies to a frequency range going beyond 6 GHz.

### Satellite Communication and Non-Terrestrial Networks

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP Release 15, 3GPP started the work to prepare NR for operation in a Non-Terrestrial Network (NTN). The work was performed within the study item “NR to support Non-Terrestrial Networks” and resulted in 3GPP TR 38.811 [1]. In 3GPP Release 16, the work to prepare NR for operation in an NTN network continued with the study item “Solutions for NR to support Non-Terrestrial Network”, which has been captured in 3GPP TR 38.821 [2]. In parallel the interest to adapt NB-IoT and LTE-M for operation in NTN is growing. 3GPP Release 17 contained both a work item on NR NTN [3] and a study item on NB-IoT and LTE-M support for NTN [4].

### Characteristics

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:

Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE.

Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Release 17, only the transparent payload architecture is considered.

FIG. 1 shows an example architecture of a satellite network with bent pipe transponders (i.e., the transparent payload architecture). The gNB may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

### Consequences of Long Propagation Delay/RTT and High Satellite Speed

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | Distance | | Onc-way | | Propagation |
|---|---|---|---|---|---|---|---|
| Orbital | | Elevation | UE <-> | | propagation | | delay |
| height | | angle | satellite | | delay | | difference |
| 600 | km | 90° | 600 | km | 2.0 | ms | — |
| | | 30° | 1075 | km | 3.6 | ms | 1.6 ms |
| | | 10° | 1932 | km | 6.4 | ms | 4.4 ms |
| 1200 | km | 90° | 1200 | km | 4.0 | ms | — |
| | | 30° | 1999 | km | 6.7 | ms | 2.7 ms |
| | | 10° | 3131 | km | 10.4 | ms | 6.4 ms |
| 35786 | km | 90° | 35786 | km | 119.4 | ms | — |
| | | 30° | 38609 | km | 128.8 | ms | 9.4 ms |

| | | | | | |
|---|---|---|---|---|---|
| 10° | 40581 | km | 135.4 | ms | 16.0 ms |

The propagation delay may also be highly variable due to the high velocity of the LEO and MEO satellites and change in the order of 10-100 μs every second, depending on the orbit altitude and satellite velocity.

For Non-Terrestrial Networks using 3GPP technology, in particular 5G/NR, the long propagation delay means that the timing advance (TA) the UE uses for its uplink transmissions is essential and has to be much greater than in terrestrial networks in order for the uplink and downlink to be time aligned at the gNB, as is the case in NR and LTE. One of the purposes of the random access (RA) procedure is to provide the UE with a valid TA (which the network later can adjust based on the reception timing of uplink transmission from the UE). However, even the random access preamble (i.e., the initial message from the UE in the random access procedure) has to be transmitted with a timing advance to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff-Chu sequence, and thus preamble, based on the same Zadoff-Chu root sequence), but this TA does not have to be as accurate as the TA the UE subsequently uses for other uplink transmissions. The TA the UE uses for the RA preamble transmission in NTN is called “pre-compensation TA”.

Various proposals are considered for how to determine the pre-compensation TA, all of which involves information originating both at the gNB and at the UE. In brief, the discussed alternative proposals include:
(1) Broadcast of a “common TA” which is valid at a certain reference point, e.g., a center point in the cell. The UE would then calculate how its own pre-compensation TA deviates from the common TA, based on the difference between the UE's own location and the reference point together with the position of the satellite. Herein, the UE acquires its own position using GNSS measurements and the UE obtains the satellite position using satellite orbital data (including satellite position at a certain time) broadcast by the network.
(2) The UE autonomously calculates the propagation delay between the UE and the satellite, based on the UE's and the satellite's respective positions, and the network/gNB broadcasts the propagation delay on the feeder link, i.e., the propagation delay between the gNB and the satellite. Herein, the UE acquires its own position using GNSS measurements and the UE obtains the satellite position using satellite orbital data (including satellite position at a certain time) broadcast by the network. The pre-compensation TA is then twice the sum of the propagation delay on the feeder link and the propagation delay between the satellite and the UE.
(3) The gNB broadcasts a timestamp (in SIB9), which the UE compares with a reference timestamp acquired from GNSS. Based on the difference between these two timestamps, the UE can calculate the propagation delay between the gNB and the UE, and the pre-compensation TA is twice as long as this propagation delay.

In conjunction with the random access procedure, the gNB provides the UE with an accurate (i.e. fine-adjusted) TA in the Random Access Response message (in 4-step RA) or MsgB (in 2-step RA), based on the time of reception of the random access preamble. The gNB can subsequently adjust the UE's TA using a Timing Advance Command MAC CE (or an Absolute Timing Advance Command MAC CE), based on the timing of receptions of uplink transmissions from the UE. A goal with such network control of the UE's timing advance is typically to keep the time error of the UE's uplink transmissions at the gNB's receiver within the cyclic prefix (which is required for correct decoding of the uplink transmissions). The time advance control framework also includes a time alignment timer that the gNB configures the UE with. The time alignment timer is restarted every time the gNB adjusts the UE's TA and if the time alignment timer expires, the UE is not allowed to transmit in the uplink without a prior random access procedure (which serves the purpose to provide the UE with a valid timing advance). For NTN, 3GPP has also agreed that in addition to the gNB's control of the UE's TA, the UE is allowed to autonomously update its TA based on estimation of changes in the UE-gNB RTT using the UE's location (e.g., obtained from Global Navigation Satellite System (GNSS) measurement) and knowledge of the serving satellite's ephemeris data and feeder link delay information from the gNB.

A second relevant aspect is that not only is the propagation delay between the UE and a satellite, or between the UE and a gNB, very long in NTN, but the due to the large distances, the difference in propagation delay to two different satellites, or two different gNBs, may be significant on the timescales relevant for cellular communication, including signaling procedures, even when the satellites/gNBs serve neighboring cells. This has an impact on all procedures involving reception or transmission in two cells served by different satellites and/or different gNBs.

A third important aspect related to the long propagation delay/RTT in Non-Terrestrial Networks is the introduction of an additional parameter to compensate for the long propagation delay/RTT. In terrestrial cellular networks, the UE-gNB RTT may range from more or less zero to several tens of microseconds in a cell. A major difference in Non-Terrestrial Networks, apart from the sheer size of the propagation delay/RTT, is that even at the location in the cell where the propagation delay/RTT is the smallest, it will be large and nowhere close to zero. In fact, the variation of the propagation delay/RTT within a NTN cell is small compared to the propagation delay/RTT. This speaks in favor of introducing an offset which essentially takes care of the RTT between the cell's footprint on the ground and the satellite, while other mechanisms, including signaling and control loops, take care of the RTT dependent aspects within the smaller range of RTT variation within the cell on top of the offset. To this end, 3GPP has agreed to introduce such a parameter, which is denoted K_{offset} (or sometimes K_offset).

The K_{offset} parameter may potentially be used in various timing related mechanisms, but the application mainly in focus is to use it in the scheduling of uplink transmissions on the PUSCH. K_{offset} is used to indicate an additional delay between the UL grant and the PUSCH transmission resources allocated by UL grant to be added to the slot offset parameter K₂ in the DCI containing the UL grant. The offset between the UL grant and the slot in which the PUSCH transmission resources are allocated is thus K_{offset}+K₂. When used this way in uplink scheduling, K_{offset} can be said to serve the purpose to ensure that the UE is never scheduled to transmit at a point in time that, due to the large TA the UE has to apply, would occur before the point in time when the UE receives the UL grant. In 3GPP, it is also discussed to let the network's configuration of K_{offset} take into account the TA the UE may have signaled that it has used.

A fourth important aspect closely related to the timing is a Doppler frequency offset induced by the motion of the satellite. The access link may be exposed to Doppler shift in the order of 10-100 kHz in sub-6 GHz frequency band and proportionally higher in higher frequency bands. Also, the Doppler shift is varying, with a rate of up to several hundred Hz per second in the S-band and several kHz per second in the Ka-band.

### Ephemeris Data

In TR 38.821 [2] it has been captured that ephemeris data should be provided to the UE, for example to assist with pointing a directional antenna (or an antenna beam) towards the satellite, and to calculate a correct Timing Advance (TA) and Doppler shift. Procedures on how to provide and update ephemeris data have not yet been studied in detail, though, but broadcasting of ephemeris data in the system information is one option.

A satellite orbit can be fully described using 6 parameters. Exactly which set of parameters is chosen can be decided by the user; many different representations are possible. For example, a choice of parameters used often in astronomy is the set (α, ε, i, Ω, ω, τ). Here, the semi-major axis α and the eccentricity ε describe the shape and size of the orbit ellipse; the inclination i, the right ascension of the ascending node Ω, and the argument of periapsis ω determine its position in space, and the epoch τ determines a reference time (e.g., the time when the satellites moves through periapsis). This set of parameters is illustrated in FIG. 2.

As an example of a different parametrization, the TLEs use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formulations (and many others) are possible choices for the format of ephemeris data to be used in NTN. To enable further progress, the format of the data should be agreed upon.

It is important that a UE can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another aspect discussed during the study item and captured in 3GPP TR 38.821 [2], is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

So, while it seems possible to provide the satellite position with the required accuracy, care needs to be taken to meet these requirements, e.g., when choosing the ephemeris data format, or the orbital model to be used for the orbital propagation.

### Some Outcomes of the 3GPP Study Items on NTN

As the outcome of the study items [1] [2] in 3GPP lay the foundation for the specification work of Non-Terrestrial Networks in 3GPP, it is relevant as background information for the present invention. The following includes some relevant information from the study items and the resulting technical reports [1] [2]:

The TR of the second study item, 3GPP TR 38.821 [2], describes scenarios for the NTN work as follows:

Non-Terrestrial Network typically features the following elements [3]:
One or several sat-gateways that connect the Non-Terrestrial Network to a public data network
A GEO satellite is fed by one or several sat-gateways which are deployed across the satellite targeted coverage (e.g., regional or even continental coverage). We assume that UE in a cell are served by only one sat-gateway
A Non-GEO satellite served successively by one sat-gateway at a time. The system ensures service and feeder link continuity between the successive serving sat-gateways with sufficient time duration to proceed with mobility anchoring and hand-over

Four scenarios are considered as depicted in Table 4.2-1 and are detailed in Table 4.2-2 [3].

TABLE 4.2-1
Reference scenarios

| | Transparent | Regenerative |
|---|---|---|
| | satellite | satellite |
| GEO based non-terrestrial access network | Scenario A | Scenario B |
| LEO based non-terrestrial access network | Scenario C | Scenario D |

TABLE 4.2-2
Reference scenario parameters

| | GEO based non- | | LEO based non- | |
|---|---|---|---|---|
| | terrestrial access network | | terrestrial access network | |
| Scenarios | (Scenario A and B) | | (Scenario C & D) | |
| Orbit type | Notional station keeping position | | Circular orbiting around | |
| | fixed in terms of elevation/azimuth | | the earth | |
| | with respect to a given earth point | | | |
| Altitude | 35,786 | km | 600 | km |
| | | | 1,200 | km |
| Spectrum (service link) | <6 GHz (e.g., 2 GHz) | | | |
| | >6 GHz (e.g., DL 20 GHz, UL 30 GHz) | | | |
| Max channel bandwidth | 30 MHz for band < 6 GHz | | | |
| (service link) | 400 MHz for band > 6 GHz | | | |
| Payload | Scenario A: Transparent (including | | Scenario C: Transparent | |
| | radio frequency function only) | | (including radio | |
| | Scenario B: regenerative (including | | frequency function only) | |
| | all or part of RAN functions) | | Scenario D: Regenerative | |
| | | | (including all or part of | |
| | | | RAN functions) | |
| Inter-Satellite link | No | | Scenario C: No | |
| | | | Scenario D: Yes | |
| Earth-fixed beams | Yes | | Scenario C: No (the | |
| | | | beams move with the | |
| | | | satellite) | |
| | | | Scenario D, option 1: | |
| | | | Yes (steering beams), see | |
| | | | note 1 | |
| | | | Scenario D, option 2: No | |
| | | | (the beams move with the | |
| | | | satellite) | |
| Max beam foot print | 500 | km | 200 | km |
| diameter at nadir | | | | |
| Min Elevation angle for | 10° | | 10° | |
| both sat-gateway and user | | | | |
| equipment | | | | |
| Max distance between | 40,586 | km | 1,932 km (600 km | |
| satellite and user | | | altitude) | |
| equipment at min | | | 3,131 km (1,200 km | |
| elevation angle | | | altitude) | |
| Max Round Trip Delay | Scenario A: 562 ms (service and | | Scenario C: 25.76 ms | |
| (propagation delay only) | feeder links) | | (transparent payload: | |
| | Scenario B: 281 ms | | service and feeder links) | |
| | | | Scenario D: 12.88 ms | |
| | | | (regenerative payload: | |
| | | | service link only) | |
| Max delay variation | 16 | ms | 4.44 | ms (600 km) |
| within a beam (earth fixed | | | 6.44 | ms (1200 km) |
| user equipment) | | | | |
| Max differential delay | 1.6 | ms | 0.65 | ms (*) |
| within a beam | | | | |
| Max Doppler shift (earth | 0.93 | ppm | 24 | ppm (*) |
| fixed user equipment) | | | | |
| Max Doppler shift | 0.000 045 | ppm/s | 0.27 | ppm/s (*) |

| variation (earth fixed user | | |
|---|---|---|
| equipment) | | |
| User equipment motion on | 1000 km/h (e.g., aircraft) | 500 km/h (e.g., high |
| the earth | | speed train) |
| | | Possibly 1000 km/h (e.g., |
| | | aircraft) |
| User equipment antenna | Omnidirectional antenna (linear polarisation), assuming 0 dBi | |
| types | Directive antenna (up to 60 cm equivalent aperture diameter in | |
| | circular polarisation) | |
| User equipment Tx power | Omnidirectional antenna: UE power class 3 with up to 200 mW | |
| | Directive antenna: up to 4 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined Radio | 3GPP or non-3GPP |
| | interface | defined Radio interface |

note 1:
Each satellite has the capability to steer beams towards fixed points on earth using beamforming techniques. This is applicable for a period of time corresponding to the visibility time of the satellite.
NOTE 2:
Max delay variation within a beam (earth fixed user equipment) is calculated based on Min Elevation angle for both gateway and user equipment.
NOTE 3:
Max differential delay within a beam is calculated based on Max beam foot print diameter at nadir.

For scenario D, which is LEO with regenerative payload, both earth-fixed and earth moving beams have been listed. So, when we factor in the fixed/non-fixed beams, we have an additional scenario. The complete list of 5 scenarios in 3GPP TR 38.821 [2] is then:
Scenario A—GEO, transparent satellite, Earth-fixed beams;
Scenario B—GEO, regenerative satellite, Earth fixed beams;
Scenario C—LEO, transparent satellite, Earth-moving beams;
Scenario D1—LEO, regenerative satellite, Earth-fixed beams;
Scenario D2—LEO, regenerative satellite, Earth-moving beams.

### IoT NTN SI Windows

FIG. 3 illustrates an NB-IoT system information block (SIB) Type-x (SIBxNB) transmission and related parameter ranges for repetition pattern within a system information (SI) window, the duration of SI window and the periodicity of SI window. The same repetition pattern is used for all SI messages. The network can configure a maximum of 80 repetitions within an SI window assuming a maximum SI window length of 160 frames (i.e., 1600 ms) and a repetition pattern where SIB is repeated in every other frame.

Similarly, for LTE-M, the possible SI window periodicities are {8, 16, 32, 64, 128, 256, 512} frames and the possible SI window lengths are {1, 2, 5, 10, 15, 20, 40, 60, 80, 120, 160, 200} ms. Similar to NB-IoT, SI messages in LTE-M can be repeated within their respective SI windows to support operation in extended coverage. Possible repetition patterns are {every frame, every second frame, every fourth frame, and every eighth frame} throughout the SI window. All SI messages have the same repetition pattern.

### Rel-17 NR NTN RAN1 Agreements

We share some key 3GPP RAN1 agreements from the Rel-17 NR NTN WI. The Rel-17 IoT NTN WI in principle inherits the same agreements. These are related to satellite ephemeris/common TA broadcast and acquisition to e.g., maintain uplink synchronization.

### Agreement

Common TA Epoch time is implicitly known as a reference time defined by the starting time of a DL slot and/or frame.
FFS: Whether this starting time is given by predefined rule or it is indicated by the Network
Note: “implicitly known” means that UTC is not provided to define the Common TA epoch time.

### Agreement

The UE assumes that it has lost uplink synchronization if new or additional assistance information (i.e. serving satellite ephemeris data or Common TA parameters) is not available within the associated validity duration.

### Agreement

The serving satellite ephemeris and common TA related parameters are signalled in the same SIB message and have the same epoch time.

### Agreement

A single validity duration for both serving satellite ephemeris and common TA related parameters is broadcast on the SIB.

### Agreement

Confirm the working assumption made at RAN1 #106-bis-e on serving satellite ephemeris bit allocations for LEO/MEO/GEO based non-terrestrial access network:
Support serving satellite ephemeris format bit allocations for LEO/MEO/GEO based non-terrestrial access network:
   Position and velocity state vector ephemeris format is 17 bytes payload.
      The field size for position (m) is 78 bits
         Position range is driven by GEO: +/−42 200 km
         The quantization step is 1.3 m for position
      The field size for velocity (m/s) is 54 bits
         Velocity range is driven by LEO@600 km: +/−8000 m/s
         The quantization step is 0.06 m/s for Velocity
   Orbital parameter ephemeris format 18 byte payload
      Semi-major axis α (m) is 33 bits
         Range: [6500, 43000] km
      Eccentricity e is 19 bits
         Range: ≤0.015
      Argument of periapsis ω (rad) is 24 bits
         Range: [0, 2π]
      Longitude of ascending node (Ω rad) is 21 bits
         Range: [0, 2π]
      Inclination i (rad) is 20 bits
         Range: [−π/2, +π/2]
      Mean anomaly M (rad) at epoch time to is 24 bits
         Range: [0, 2π]

### Agreement

When explicitly provided through SIB, Epoch time of assistance information (i.e. Serving satellite ephemeris and Common TA parameters) is the starting time of a DL sub-frame, indicated by a SFN and a sub-frame number signaled together with the assistance information.

Otherwise, when indicated in SIB (other than SIB1), epoch time of assistance information (i.e. Serving satellite ephemeris and Common TA parameters) is implicitly known as the end of the SI window during which the SI message is transmitted.

When provided through dedicated signaling, epoch time of assistance information (i.e. Serving satellite ephemeris and Common TA parameters) is the starting time of a DL sub-frame, indicated by a SFN and a sub-frame number.

### Agreement

Modify second bullet of RAN1 #107-e agreement on Epoch time as follows:

Otherwise, when Epoch time is not explicitly indicated in SIB, epoch time of assistance information (i.e. Serving satellite ephemeris and Common TA parameters) is implicitly known as the end of the SI window during which the NTN-specific SIB is transmitted.

### Agreement

Add one additional NTN validity duration value for GEO i.e. 900 seconds. X=4 bits.

### Agreement

Modify bit allocations for orbital parameters ephemeris format as follows:
Orbital parameters are indicated in 21 bytes payload:
   Semi-major axis α (m) is 33 bits
      Range: from 6500 km to 43000 km
      The quantization step is 4.249×10⁻³ m
   Eccentricity e is 20 bits
      Range: ≤0.015
      The quantization step is 1.431×10⁻⁸
   Argument of periapsis ω (rad) is 28 bits
      Range: from 0 to 2π
      The quantization step is 2.341×10⁻⁸ rad
   Longitude of ascending node (Ω 2 rad) is 28 bits
      Range: from 0 to 2π
      The quantization step is 2.341×10⁻⁸ rad
   Inclination i (rad) is 27 bits
      Range: from −π/2 to +π/2
      The quantization step is 2.341×10⁻⁸ rad
   Mean anomaly M (rad) at epoch time to is 28 bits
      Range: from 0 to 2π
      The quantization step is 2.341×10⁻⁸ rad

### CONCLUSION

Confirm that the agreed position and velocity state vector ephemeris format for LEO/MEO/GEO may also be applied for HAPS/ATG.

### NTN SIB Agreements in Rel-17 IoT NTN WI

IoT NTN has introduced two NTN-specific SIBs.

The first SIB contains information elements required to synchronize to the cell such as ephemeris information, common TA parameters, the uplink sync validity timer duration, epoch time for assistance information. Some of the agreements of the NTN SIB include.

### RAN2 #116-e:

The serving cell ephemeris information (used for L1 pre-compensation) is signalled in a new SIB, which is NTN specific.
Update to serving cell ephemeris information does not affect the system information value tag and does not trigger System information modification procedure. How to trigger re-read of this information is FFS. FFS if the UE shall reacquire the new SIB when SI update is triggered.
The timing information on when a serving cell is going to stop serving the area is broadcast in the same SIB as the ephemeris information.
   RAN2 #116bis-e:
TA common parameters, UL synchronisation validity duration and ephemeris epoch time are signalled in the NTN specific SIB (SIBXX).
K_offset and K_mac parameters are signalled in the NTN specific SIB (SIBXX).
UE acquires the NTN specific SIB before accessing the cell.

### RAN2 #117-e:

SIBXX is an essential SIB, i.e. the UE shall consider the cell barred if it is unable to acquire the SIB when scheduled.
UE shall acquire the NTN specific SIB before accessing the cell, regardless of the state of UL sync validity timer.
FFS if we Will have a guard timer to handle the case where the UE takes ‘forever’ reacquire the SIB. At timer expiry UE triggers RLF handling. (Note that it is expected that the timer will not expire in the normal case, and the UE can just come back to previous decision).
For simplicity, the whole SIBXX structure is included in RRCReconfiguration message for handover.
Introduce a guard timer TXXXX for SIBXX acquisition in connected mode. At TXXX expiry, UE triggers RLF (if it can be shown in Q2 that UE will loose RLM when UE tunes away, it can be discussed to skip this timer).
Introduce a presence indicator in addition to the 2 bit LSB EARFCN in the NB-IoT MIB (eMTC-all aspects FFS)
Upon timer expiry (or UE tune away), UE stops all UL transmissions, flushes all HARQ buffers and maintains all UL resources.
The UL synchronisation validity timer is maintained in RRC.
Modified Proposal 4: SIBXX acquisition is captured in 5.2.2. UE actions upon ul-Sync ValidityTimer expiry are described in a new section in 5.3.3, which will refer to 5.2.2 for SIBXX (re) acquisition
SIBXX is included outside mobilityControlInfo, similarly to other dedicated SIB.

In the latest CR [8], the following has been specified:

### 2.1.4.1 SystemInformationBlockType31

The IE SystemInformationBlockType31 contains satellite assistance information for the serving cell.

SystemInformationBlockType31 information element

-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

...
}

| | |
|---|---|
| ServingSatelliteInfo-r17 ::= | SEQUENCE { |
| ephemerisInfo-r17 | CHOICE { |
| stateVectors | EphemerisStateVectors-r17, |
| orbitalParameters | EphemerisOrbitalParameters-r17 |

},

| nta-CommonParameters-17 | SEQUENCE { | |
|---|---|---|
| nta-Common-r17 | INTEGER (0..8316827) | OPTIONAL, -- Need |

OP

| | |
|---|---|
| nta-CommonDrift-r17 | INTEGER (−261935..261935) OPTIONAL, -- Need |

OP

| | | |
|---|---|---|
| nta-CommonDriftVariation-r17 | INTEGER (0..29470) | OPTIONAL -- Need |

OP
},

| | |
|---|---|
| ul-SyncValidityDuration-r17 | ENUMERATED {s5, s10, s15, s20, s25, s30, |

s35, s40,

s45, s50, s55, s60, s120, s180, s240},

| | |
|---|---|
| epochTime-r17 | SEQUENCE { |
| startSFN-r17 | INTEGER (0..1023), |

| | |
|---|---|
| startSubFrame-r17 | INTEGER (0..9) |

| } | | OPTIONAL, -- Need OP |
|---|---|---|
| k-Offset-r17 | INTEGER (0..1023), | |
| k-Mac-r17 | INTEGER (1..512) | OPTIONAL, -- Need OP |

...
}
-- ASN1STOP

The second SIB has been introduced to broadcast information that is needed to handle discontinuous coverage scenario in IoT NTN, e.g., it includes information elements containing satellite ephemeris of neighbouring and upcoming satellites so that the UE knows when to wake up to receive coverage. This is useful in scenarios e.g., low-density or sparse LEO constellations where the number of satellites in the constellation are not enough to cover the whole earth at a given time.

Some agreements related to this:
RAN2 will use a new SIB to share the ephemeris information for Discontinuous Coverage with the UEs. Sharing the information using dedicated RRC signalling is FFS.
For Discontinuous Coverage, ephemeris information of up to a maximum X satellites can be shared using the new SIB, where X is limited by the volume of information vs capacity of the SIB (X=4 is baseline). Increasing this maximum number by using dedicated RRC Signalling and by any further ephemeris optimization is FFS.

### Epoch Time Indication

With explicit epoch time indication, the epoch time is included in the NTN SIB. Therefore, the content of the NTN SIB remains unchanged as long as the epoch time remains unchanged (in addition to the common TA parameters, the ephemeris and the validity timer remaining unchanged). In one example, epoch time can be indicated up to 5.12 sec into the past or future (with the possibility to indicate epoch time in both the past and the future), or up to 10.24 sec into the future or into the past (with the possibility to indicate the epoch time in the past only or in the future only). Since NTN SIB is an essential SIB, it is expected to be transmitted with a shorter SI periodicity e.g., at least once a second. This means that there is a large number of SI windows within a validity timer duration for both LEO and GEO (as evident from Table 2 and Table). However, due to explicit epoch time indication, there is an additional limit of 5.12 sec (or 10.24 sec) on the SI accumulation duration.

For explicit epoch time indication, without introducing additional signalling, the epoch time indication range essentially limits the SIB accumulation to shorter SI periodicities of up to 64 frames.

### SUMMARY

The disclosure includes the following general embodiments and encompasses combinations of the following features.

### GENERAL GROUP EMBODIMENTS

G1. A method by a user equipment or network node to facilitate NTN SIB accumulation in NTN to allow operation in coverage limited condition and to avoid decoding error when NTN SIB contents change frequently for either or both implicit and explicit epoch time indication, the method comprising:
any of the user equipment or network node steps, features, or functions described above, either alone or in combination with other steps, features, or functions described above.

G2. The method of the previous embodiment, further comprising one or more additional user equipment steps, features or functions described above.

G3. The method of any of the previous embodiments, further comprising:
providing user data; and
forwarding the user data to a host computer via the transmission to the network node.

G4. A user equipment of network node having hardware configured to facilitate NTN SIB accumulation in NTN to allow operation in coverage limited condition and to avoid decoding error when NTN SIB contents change frequently for both implicit and explicit epoch time indication, by performing any of the user equipment or network node steps, features, or functions described above, either alone or in combination with other steps, features, or functions described above.

### GROUP A EMBODIMENTS

A1. A method performed by a user equipment (UE) for to facilitate NTN SIB accumulation, the method comprising:
determining, based on one or more SI configuration parameters, whether NTN SIB accumulation should be performed; and
performing NTN SIB accumulation when the UE determines NTN SIB accumulation should be performed; or
not performing NTN SIB accumulation when the UE determines NTN SIB accumulation should not be performed.

A2. The method of embodiment A1, further comprising the step of:
determining that the network does not explicitly indicate whether NTN SIB accumulation should be performed;
thereafter determining, based on one or more SI configuration parameters, whether NTN SIB accumulation should be performed.

A3. The method of any of the previous embodiments, wherein the one or more SI configuration parameters comprises an SI periodicity value.

A4. The method of any of the previous embodiments, wherein the one or more SI configuration parameters comprises an epoch timer indication range and/or a number of SI windows.

A5. The method of embodiment A1 or A2, wherein the UE determines whether the network is using explicit or implicit epoch time indication based on one of:
an indication in SI other than the NTN SIB;
an assumption of explicit epoch time in the absence of an indication of implicit epoch time;
an assumption of implicit epoch time in the absence of an indication of explicit epoch time; or
an inference based on a parameters signalled in the SI.

A6. The method of embodiment A1 or A2, wherein the one or more parameters includes an validity timer update.

A7. The method of embodiment A1 or A2, wherein determining, based on the one or more parameters, comprises determining based on the absence or one or more parameters whether NTN SIB accumulation should be performed.

A8. The method of any of the previous embodiments, further comprising:
providing user data; and
forwarding the user data to a host via the transmission to the network node.

A9. A method performed by a user equipment (UE) for to facilitate NTN SIB accumulation, the method comprising:
determining that NTN SIB accumulation should be performed in the absence of an indication from the network to perform NTN SIB accumulation; and
performing NTN SIB accumulation when the UE determines NTN SIB accumulation should be performed.

A10. The method of embodiment A9, further comprising decoding an NTN SIB.

A11. The method of embodiment A10, wherein decoding an NTN SIB comprises:
attempting to decode the NTN SIB;
if the attempting to decode the NTN is successful, storing the NTN SIB and receiving and storing an additional NTN SIB in a next SI transmission.
store the first NTN SIB and receive and store the second NTN SIB in the next SI transmission.

A12. The method of embodiment A11, further comprising:
attempting to decode the additional NTN SIB without combining the NTN SIB and the additional NTN SIB; or
attempting to decode the additional NTN SIB by combining the first stored NTN SIB and the second NTN SIB.

### GROUP B EMBODIMENTS

B1. A user equipment for facilitating NTN SIB accumulation in NTN to allow operation in coverage limited condition and to avoid decoding error when NTN SIB contents change frequently for either or both implicit and explicit epoch time indication, comprising:
processing circuitry configured to perform any of the steps of any of the Group A or General Group embodiments; and
power supply circuitry configured to supply power to the processing circuitry.

B2. A user equipment (UE) for facilitating NTN SIB accumulation in NTN to allow operation in coverage limited condition and to avoid decoding error when NTN SIB contents change frequently for either or both implicit and explicit epoch time indication, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A or General Group embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

B3. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

B4. The host of the previous embodiment, wherein:
the processing circuitry of the host is configured to execute a host application that provides the user data; and
the UE comprises processing circuitry configured to execute a client application associated with the host application to receive the transmission of user data from the host.

B5. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

B6. The method of the previous embodiment, further comprising, at the network node, transmitting the user data provided by the host for the UE.

B7. The method of any of the previous 2 embodiments, wherein the user data is provided at the host by executing a host application that interacts with a client application executing on the UE, the client application being associated with the host application.

B8. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

B9. The communication system of the previous embodiment, further comprising:
the network node; and/or
the UE.

B10. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

B11. The host of the previous 2 embodiments, wherein:
the processing circuitry of the host is configured to execute a host application that receives the user data; and
the host application is configured to interact with a client application executing on the UE, the client application being associated with the host application.

B12. The host of the any of the previous 2 embodiments, wherein the initiating receipt of the user data comprises requesting the user data.

B13. The method of the previous embodiment, further comprising at the network node, transmitting the received user data to the host.

B14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A or General Group embodiments to receive the user data from the host.

B16. The host of the previous embodiment, wherein the cellular network further includes a network node configured to communicate with the UE to transmit the user data to the UE from the host.

B17. The host of the previous 2 embodiments, wherein:
the processing circuitry of the host is configured to execute a host application, thereby providing the user data; and
the host application is configured to interact with a client application executing on the UE, the client application being associated with the host application.

B18. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A or General Group embodiments to receive the user data from the host.

B19. The method of the previous embodiment, further comprising:
at the host, executing a host application associated with a client application executing on the UE to receive the user data from the host application.

B20. The method of the previous embodiment, further comprising:
at the host, transmitting input data to the client application executing on the UE, the input data being provided by executing the host application,
wherein the user data is provided by the client application in response to the input data from the host application.

B21. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A or General Group embodiments to transmit the user data to the host.

B22. The host of the previous embodiment, wherein the cellular network further includes a network node configured to communicate with the UE to transmit the user data from the UE to the host.

B23. The host of the previous 2 embodiments, wherein:
the processing circuitry of the host is configured to execute a host application, thereby providing the user data; and
the host application is configured to interact with a client application executing on the UE, the client application being associated with the host application.

B24. A method implemented by a host configured to operate in a communication system that further includes a network node and a user equipment (UE), the method comprising:
at the host, receiving user data transmitted to the host via the network node by the UE, wherein the UE performs any of the steps of any of the Group A or General Group embodiments to transmit the user data to the host.

B25. The method of the previous embodiment, further comprising:
at the host, executing a host application associated with a client application executing on the UE to receive the user data from the UE.

B26. The method of the previous 2 embodiments, further comprising:
at the host, transmitting input data to the client application executing on the UE, the input data being provided by executing the host application,
   wherein the user data is provided by the client application in response to the input data from the host application.

### BRIEF DESCRIPTION OF THE DRAWINGS

For a more complete understanding of the present disclosure, reference is now made to the following descriptions taken in conjunction with the accompanying drawings, in which:

FIG. 1 shows an example architecture of a satellite network with bent pipe transponders (i.e., the transparent payload architecture).

FIG. 2 depicts a satellite orbit fully described using 6 parameters.

FIG. 3 illustrates an NB-IoT SIB Type-x (SIBxNB) transmission and related parameter ranges for repetition pattern within an SI window, the duration of SI window and the periodicity of SI window.

FIG. 4 shows an example of a communication system 400 in accordance with some embodiments.

FIG. 5 shows a UE 500 in accordance with some embodiments. The UE 500 may be an embodiments of the device shown communicating with the satellite in FIG. 1.

FIG. 6 shows a network node 600 in accordance with some embodiments.

FIG. 7 is a block diagram of a host 700, which may be an embodiment of the host 416 of FIG. 4, in accordance with various aspects described herein.

FIG. 8 is a block diagram illustrating a virtualization environment 800 in which functions implemented by some embodiments may be virtualized.

FIG. 9 shows a communication diagram of a host 902 communicating via a network node 904 with a UE 906 over a partially wireless connection in accordance with some embodiments.

FIG. 10 is a flowchart of a method 1000, according to some embodiments.

FIG. 11 is a flowchart of a method 1100, according to some embodiments.

### DETAILED DESCRIPTION

There currently exist certain challenge(s). One unsolved issue for IoT NTN is how to handle NTN SIB accumulation across SI windows. Both LTE-M and NB-IoT allow SIB repetitions within an SI window. Additionally, the UEs can also possibly accumulate SIBs across multiple SI windows if needed (except for the SIBs that change frequently such as SIB16 as specified in the 3GPP specifications).

If the content of NTN SIB remains unchanged across multiple SI windows, it is beneficial to allow SIB accumulation over those windows to overcome poor coverage. However, if one or more of the NTN SIBs in the accumulated SI windows are different, it may lead to a decoding error and accumulation should be avoided.

The content of the NTN SIB(s) is partly dynamic (e.g., the ephemeris data and the Common TA parameters), which is thus problematic when SIB accumulation is needed, e.g., for sufficiently good reception at the cell edge.

Therefore, solutions are needed to facilitate accumulation of NTN SIB where needed. In the Appendix, more generic solutions for this problem were proposed. However, this disclosure provides detailed solutions for explicit and implicit epoch time indication.

Certain aspects of the disclosure and their embodiments may provide solutions to these or other challenges. We describe methods and signalling to facilitate NTN SIB accumulation in NTN to allow operation in coverage limited condition and to avoid decoding error when NTN SIB contents change frequently for both implicit and explicit epoch time indication. Signalling and methods to determine if NTN-specific SIB accumulation across SI windows should be performed in an IoT NTN cell based on other SI configuration parameters. Signalling and methods to indicate if implicit or explicit epoch time is used in an NTN cell. Methods to perform blind decoding of NTN SIBs when UE received only partial or no knowledge about NTN SIB accumulation from the network. Signalling and methods to perform decoding of NTN SIBs when the validity timer changes from SIB to SIB even if other contents of the SIB remain unchanged.

Certain embodiments may provide one or more of the following technical advantage(s). The proposed solutions provide methods to facilitate accumulation of NTN-specific SIBs across multiple SI windows for NTN UEs in poor coverage while avoiding decoding errors due to NTN-specific SIB accumulation.

Some of the embodiments contemplated herein will now be described more fully with reference to the accompanying drawings. Embodiments are provided by way of example to convey the scope of the subject matter to those skilled in the art.

NOTE1: SIB accumulation refers to accumulating NTN-specific SIB (which contains satellite ephemeris and/or other assistance information for NTN; and also referred to as NTN SIB) across one or more SI windows.

NOTE2: One or more of the ideas described herein for IoT NTN can also be applied to NR NTN, and/or other scenarios where SIB accumulation is desired for a SIB that changes frequently.

NOTE3: “Updating NTN SIB” means that the contents of the NTN SIB are updated.

NOTE4: The invention is about NTN SIB accumulation and does not alter the defined UE behavior with regards to accumulation of other legacy SIBs. That is, the UE might as well accumulate other SIBs as done in terrestrial networks.

NOTE5: There are technically 2 different NTN SIBs in IoT NTN (SystemInformationBlockType31 and SystemInformationBlockType32), where the invention can be relevant as both may update its ephemeris in between SI windows.

NOTE6: The invention described herein may be used in conjunction with one or more of the methods described in the Appendix.

### SIB Accumulation Based on SI Configuration

In the Appendix, the following example was captured:

Example 4: SIB accumulation is prohibited if the SI periodicity exceeds the NTN SIB broadcast periodicity, and/or the number of repetitions configured for the SIBs exceed a certain value. The UE may determine these periodicities and repetition pattern from system information, and then determine if it is allowed to accumulate the NTN SIB or not.

In this Document, we Include Additional Detailed Embodiments on NTN SIB Accumulation and SI Configuration Parameters.

In one embodiment, one or more of the SI configuration parameters are used by the UE to determine whether NTN SIB accumulation is allowed. In a sub-embodiment, the SI periodicity is used by the UE to determine whether NTN SIB accumulation is allowed.

This can be defined in a standard specification e.g., certain SI configuration parameters values for which NTN SIB accumulation is possible can be fixed and specified in the specification, and/or this can be left up to UE implementation. Alternatively, or additionally, the network may indicate whether or not the UE may use SI configuration parameters to determine if it can accumulate NTN SIB. In another embodiment, the UE determines whether or not it is feasible to accumulate NTN SIB by using SI configuration parameters along with other parameters such as the remaining service time before the NTN cell changes (T_service), the satellite orbit or constellation type, satellite beam type (earth-fixed or moving), the previous ephemeris validity timer value stored in the UE, and/or whether it has successfully used NTN SIB accumulation in previous attempt(s), whether it is an NB-IoT or an eMTC UE, epoch time indication range (and/or whether it is indicated in the past or the future), etc.

In one embodiment, one or more of the SI configuration parameters are used by the UE to determine whether NTN SIB accumulation should be performed. For example, if the network does not explicitly indicate information to allow or prohibit NTN SIB accumulation in a cell and leaves it up to the UE to decide, the UE may use SI configuration parameter values to decide if it should accumulate NTN SIBs across SI windows. In a sub-embodiment, the SI periodicity is used by the UE to determine whether NTN SIB accumulation should be performed

We give several examples of the above embodiments for explicit epoch time in the following subsection.

### Explicit Epoch Time

Let us consider the case where epoch time is explicitly signalled in the NTN SIB. Even if the ephemeris, the common TA parameters, the validity timer duration and the epoch time remain unchanged, it is the epoch time indication range that will determine how long the can the NTN SIB be transmitted unchanged before it needs to be updated. For example, if the epoch time indication range is 5.12 sec (or 10.24 sec), the time period over which the NTN SIB content may remain unchanged will be up to 5.12 sec (or 10.24 sec). After this time, the contents may need to be updated to correspond to the new epoch time (unless there is additional signalling introduced in the SI to assist the decoding process).

Depending on the NTN scenario, it is up to the network how frequently it transmits and updates the NTN SIB. Based on the parameter values for the SI configuration and the validity timer, we analyze the potential scenarios where NTN SIB accumulation may be feasible. In Table for eMTC and Table for NB-IoT, we observe that there are many combinations of the SI periodicity and the UL synchronization validity timer duration for which the ephemeris is expected to remain unchanged. The smaller validity timer values mainly apply to LEO scenarios whereas the larger validity timer values are for GEO scenarios. Since eMTC supports a much smaller SI periodicity than NB-IoT, the NTN SIB can be transmitted more frequently in eMTC than in NB-IoT. This means that there can be a greater number of SI windows in a certain time duration in eMTC than in NB-IoT. Nonetheless, for both eMTC and NB-IoT, it is possible to accumulate NTN-SIB over multiple SI windows. Moreover, the smaller the SI periodicity, the more the number of SI windows within a certain time period. Therefore, if the network roughly updates NTN SIB on the same order as the validity timer, the number of SI windows that can be accumulated for NTN SIB decoding are reflected in these tables. However, if we account for the additional limitation due to epoch time indication range, then the number of possible NTN SIB that can be accumulated are roughly given by the first row (regardless of the validity timer) assuming an indication range of 5.12 sec; or the first row second row assuming an indication range of 10.24 sec (and a validity timer of 5 sec), or the second row assuming an indication range of 10.24 sec (and a validity timer of 10 sec or higher).

TABLE 2
Number of eMTC NTN SIBs that can be accumulated
before the validity timer expires.

| Validity | eMTC SI window periodicity (sec) | | | | | | |
|---|---|---|---|---|---|---|---|
| timer | 0.08 | 0.16 | 0.32 | 0.64 | 1.28 | 2.56 | 5.12 |
| (sec) | Number of eMTC SI windows within a validity timer duration | | | | | | |
| 5 | 62 | 31 | 15 | 7 | 3 | 1 | — |
| 10 | 125 | 62 | 31 | 15 | 7 | 3 | 1 |
| 15 | 187 | 93 | 46 | 23 | 11 | 5 | 2 |
| 30 | 375 | 187 | 93 | 46 | 23 | 11 | 5 |
| 60 | 750 | 375 | 187 | 93 | 46 | 23 | 11 |
| 120 | 1500 | 750 | 375 | 187 | 93 | 46 | 23 |
| 180 | 2250 | 1125 | 562 | 281 | 140 | 70 | 35 |
| 240 | 3000 | 1500 | 750 | 375 | 187 | 93 | 46 |
| 900 | 11250 | 5625 | 2812 | 1406 | 703 | 351 | 175 |

TABLE 3
Number of NB-IoT NTN SIBs that can be accumulated
before the validity timer expires.

| Validity | NB-IoT SI window periodicity (sec) | | | | | | |
|---|---|---|---|---|---|---|---|
| timer | 0.64 | 1.28 | 2.56 | 5.12 | 10.24 | 20.48 | 40.96 |
| (sec) | Number of NB-IoT SI windows within a validity timer duration | | | | | | |
| 5 | 7 | 3 | 1 | — | — | — | — |
| 10 | 15 | 7 | 3 | 1 | — | — | — |
| 15 | 23 | 11 | 5 | 2 | 1 | — | — |
| 30 | 46 | 23 | 11 | 5 | 2 | 1 | — |
| 60 | 93 | 46 | 23 | 11 | 5 | 2 | 1 |
| 120 | 187 | 93 | 46 | 23 | 11 | 5 | 2 |
| 180 | 281 | 140 | 70 | 35 | 17 | 8 | 4 |
| 240 | 375 | 187 | 93 | 46 | 23 | 11 | 5 |
| 900 | 1406 | 703 | 351 | 175 | 87 | 43 | 21 |

### Example

With explicit epoch time, SI periodicity value can be used to determine whether or not the UE should accumulate the NTN SIB. Based on the results in the above tables, in one instance,
if it exceeds 64 radio frames, the IoT NTN UE may assume that NTN SIB accumulation is not allowed. There is no additional signalling needed in this case as SI periodicity will be signalled by the network anyways which is all the UE needs to decide whether to accumulate NTN SIB.

In another example, NTN SIB accumulation in eMTC NTN is allowed for the following SI periodicities: {8, 16, 32, 64} frames.

In yet another example, NTN SIB accumulation in eMTC NTN is allowed for the following SI periodicities: {8, 16, 32} frames.

In one embodiment, NTN SIB accumulation in NB-IoT NTN is allowed for the following SI periodicities: {64} frames.

In the above examples, the mentioned SI periodicities can be specified in the specification and/or optionally indicated by the network in System Information (other than the NTN SIBs).

In another example, NTN SIB accumulation is left up to UE implementation. In that case, the UE may decide based on the epoch timer indication range, and number of SI windows to decide whether to attempt NTN SIB accumulation.

Explicit Vs. Implicit Epoch Time Differentiation

How does the UE know if the network is using explicit or implicit epoch time indication?

In one embodiment, the network indicates it in the SI (other than the NTN SIB) if it using implicit or explicit epoch time indication, e.g., using a 1-bit field in SIB1.

In another embodiment, if different parameters are signalled in SI for NTN SIB accumulation for explicit epoch time and implicit epoch time, the UE can infer based on the parameter signalled if the network is using implicit epoch time or explicit epoch time.

If no additional signalling is introduced for explicit epoch time, but it is introduced for explicit epoch time: if the relevant parameters for implicit epoch time are included in SI, the UE will assume that implicit epoch time is supported. Otherwise, it will assume that explicit epoch time is supported.

If no additional signalling is introduced for implicit epoch time, but it is introduced for explicit epoch time: if the relevant parameters for explicit epoch time are included in SI, the UE will assume that explicit epoch time is supported. Otherwise, it will assume that implicit epoch time is supported.

### NTN SIB Accumulation Despite Validity Timer Update

If some of the contents of NTN SIB remain the same i.e., ephemeris, common TA parameters, and epoch time (if epoch time is transmitted) remain unchanged but the validity timer gets updated, the UE may still accumulate and attempt to decode the NTN SIBs if the validity timer is updated in a predictable manner. For instance, if the SI periodicity is 5.12 seconds and the UE determines it can accumulate NTN SIBs, and it attempts to decode using 2 NTN SIBs, it can assume that the validity timer in the second SIB is ~5 seconds smaller than the first NTN SIB. Since it is aware of the validity timer bits that are different in the two NTN SIBs, it can incorporate this information while combining the two SIBs.

In another embodiment, the network may indicate in SI whether or not the validity timer indicated in the NTN SIB can be assumed to be constant for NTN SIB accumulation.

In another embodiment, if the network indicates any information related to facilitate NTN SIB accumulation, it is assumed that the validity timer value will remain unchanged if other content of the NTN SIB remains unchanged.

In another embodiment, if the network indicates any information related to facilitate NTN SIB accumulation, it is assumed that the validity timer value will change for each SIB according to the validity timer granularity and SI periodicity, even if other content of the NTN SIB remains unchanged.

In another embodiment, if the network uses explicit epoch time indication, it is assumed that the validity timer value will remain unchanged if other content of the NTN SIB remains unchanged.

In another embodiment, if the network uses implicit epoch time indication, it is assumed that the validity timer value will remain unchanged if other content of the NTN SIB remains unchanged.

In another embodiment, if the network uses explicit epoch time indication, it is assumed that the validity timer value will change for each SIB according to the validity timer granularity and SI periodicity, even if other content of the NTN SIB remains unchanged.

In another embodiment, if the network uses implicit epoch time indication, it is assumed that the validity timer value will change for each SIB according to the validity timer granularity and SI periodicity, even if other content of the NTN SIB remains unchanged.

In another embodiment, the satellite orbit (e.g., LEO, MEO or GEO) determines whether the validity timer indicated in the NTN SIB can be assumed to be constant for NTN SIB accumulation, where this rule can be defined in a specification.

Blind NTN SIB Decoding with Accumulation

In the Appendix, it was captured that “In one embodiment, once the UE has determined that NTN SIB accumulation is not prohibited, it is left up to the UE implementation to determine the number of SI windows across which NTN SIBs can be accumulated. For example, the UE may opportunistically attempt to decode the NTN SIB by accumulating across SI windows on a trial-and-error basis. It may also use orbit prediction algorithms or other side information such as uplink synchronization validity timer values or previously acquired satellite ephemeris/common TA parameters to estimate how frequently the satellite ephemeris/common TA etc. will be updated by the network. Then, it can attempt to accumulate the NTN SIB in SI windows which fall within its estimated duration during which the NTN SIB content is expected to remain unchanged.”

In this invention, we provide some additional embodiments for NTN SIB accumulation regardless of whether the UE has any prior information about NTN SIB decoding.

In one embodiment, the UE may blindly attempt to accumulate NTN SIBs for decoding purposes even if the network has not indicated any information to assist the UE in deciding whether to accumulate NTN SIBs and/or when to start/stop accumulating NTN SIBs.

Example: Let us assume that the NTN SIB remains unchanged for N consecutive SI windows but the UE does not have any knowledge about the parameter “N” and/or about the starting or ending time of this set of N SI windows (i.e., it does not know the starting SI window (that contains the SI message for the NTN SIB) for this set of SI windows and/or the last SI window for this set of SI windows). In this case, the UE may test multiple hypothesis while decoding an NTN SIB. E.g.,

It can attempt to first decode an NTN SIB.

If it is unsuccessful, it can store the first NTN SIB and receive and store the second NTN SIB in the next SI transmission. It can attempt to decode the second NTN SIB on its own and/or attempt to decode the NTN SIB by combining the first stored NTN SIB and the second NTN SIB.

If still unsuccessful, it may continue to receive, store, and attempt to combine multiple NTN SIBs until it successfully decodes the NTN SIB or after a certain number of unsuccessful decoding or combining attempts, and/or until it has stored a certain number of NTN SIBs as per its memory constraints, and/or as per its knowledge of the SI periodicity or other related parameters.

The UE may use additional information about coverage to aid this decoding process. For example, if the UE can estimate the number of NTN SIBs “X” that it may need to accumulate based on the previous successful acquisition of NTN SIBs or of SIBs other than the NTN SIB, and/or other information related to coverage such as RSRP/RSRQ levels, and/or SI configuration parameters. The UE may begin the decoding process with its assessment of “X” and only combine up to X SI windows or at least X SI windows. If its decoding attempts fail, it may increment the number X until successful decoding.

In another example, if the UE has received and stored K NTN SIBs, it may attempt to combine the first k (k=1, . . . ,K) of those NTN SIBs starting from the first NTN SIB. Alternatively, it may combine k NTN SIBs (k=1, . . . ,K) starting from the m^{th} NTN SIB (where m=1, . . . ,K) in the set of those K NTN SIBs.

In another example, the UE adopts a “sliding window” approach while receiving and combining NTN SIBs for decoding, i.e., the set of “K” NTN SIBs is updated by removing older SIBs and adding newer SIBs if the UE has had a certain number of unsuccessful attempts with decoding using older SIB. E.g., if X=3, the UE may accumulate up to K=3 NTN SIBs for decoding. The UE may attempt to decode the first, second and third NTN SIBs separately but they will fail if UE's assessment of X=3 is correct. Then, the UE may try out combining the first and the second or the second and the third NTN SIBs but these attempts would also fail. Finally, it can attempt to combine all the three SIBs. If this attempt is unsuccessful, UE may flush out the first NTN SIB and acquire another NTN SIB (which will be the third NTN SIB) and attempt to decode with this set of three NTN SIBs. If still unsuccessful, the UE can again remove the first NTN SIB and add a new NTN SIB. If still unsuccessful, the UE may increment X by 1 and restart the entire procedure.

In another embodiment, the UE may flush out the older NTN SIBs that it had stored for accumulation, e.g., to free memory to stored additional NTN SIBs.

In another embodiment, the UE may test additional hypothesis depending on whether it assumed the validity timer transmitted in the NTN SIB to remain unchanged (if other SIB content remain unchanged) or not.

In another embodiment, the SIB accumulation described in this document targets a specific NTN SIB, which is either the NTN SIB needed for uplink synchronization (SystemInformationBlockType31) or the NTN SIB used for discontinuous coverage (SystemInformationBlockType32). This can be specified and/or additionally indicated to the UE. Alternatively, SIB accumulation information is applicable to both NTN SIBs.

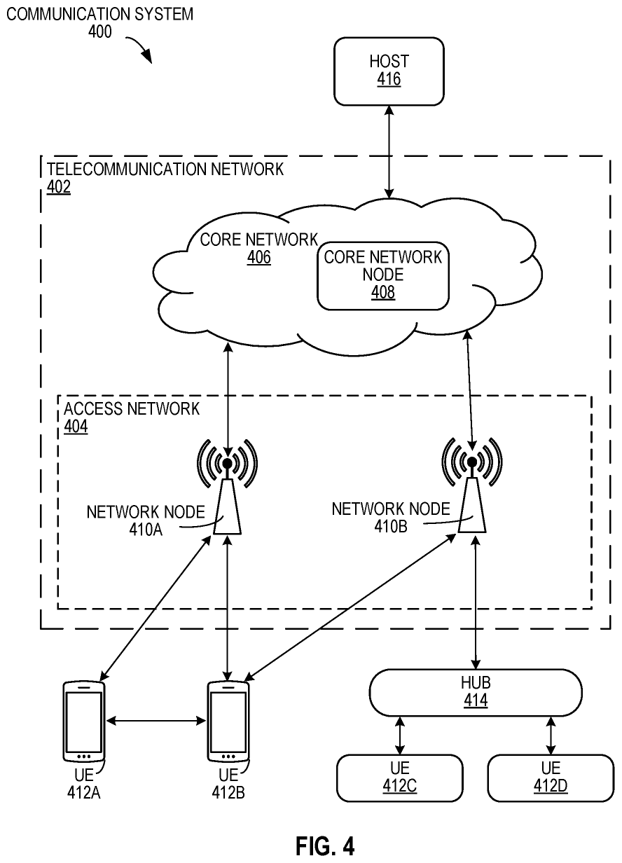

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

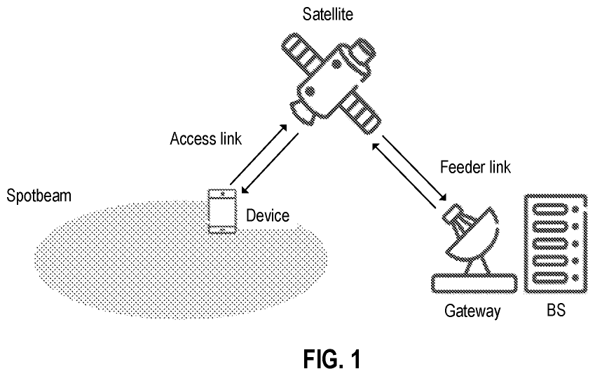

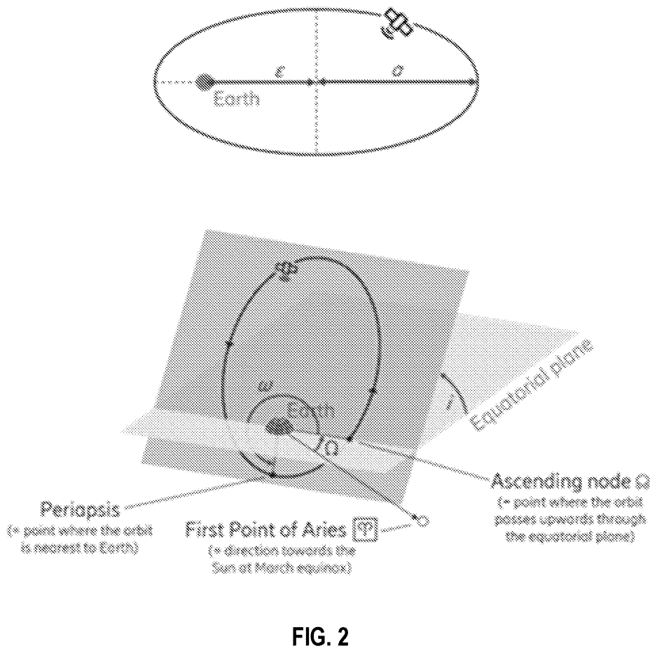

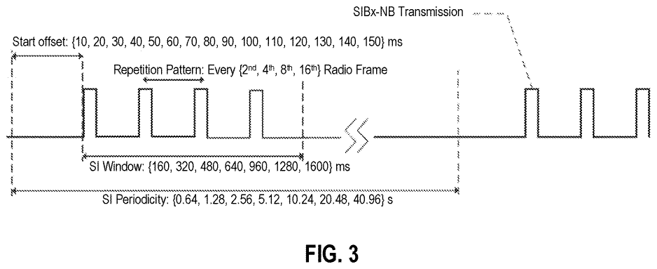

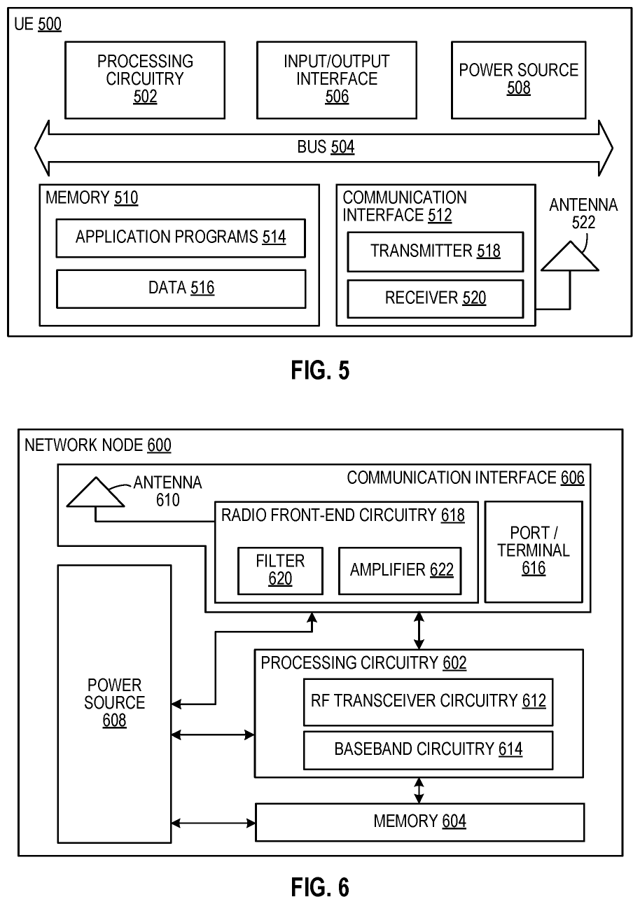

FIG. 5 shows a UE 500 in accordance with some embodiments. The UE 500 may be an embodiments of the device shown communicating with the satellite in FIG. 1 via the access link. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. The network node 600 may be included in embodiments of the satellite shown in FIG. 1. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

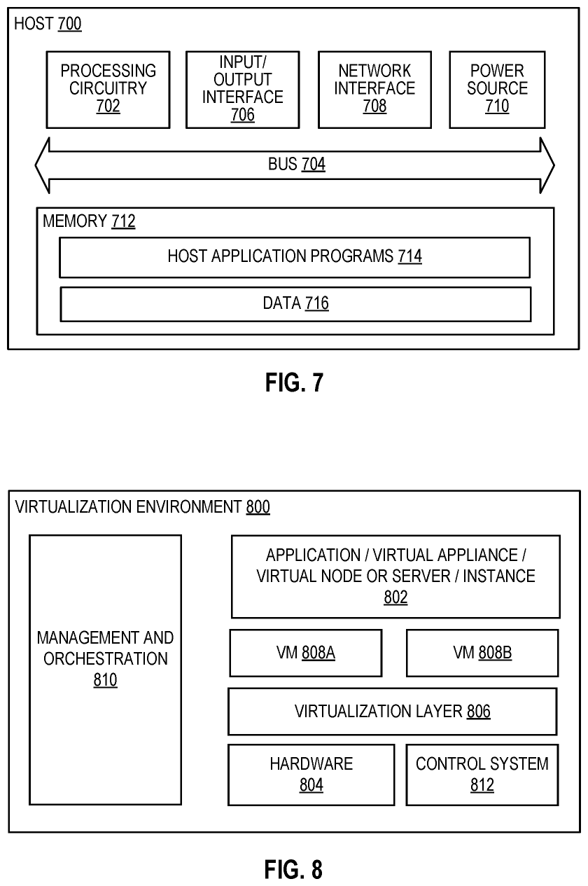

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g., such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

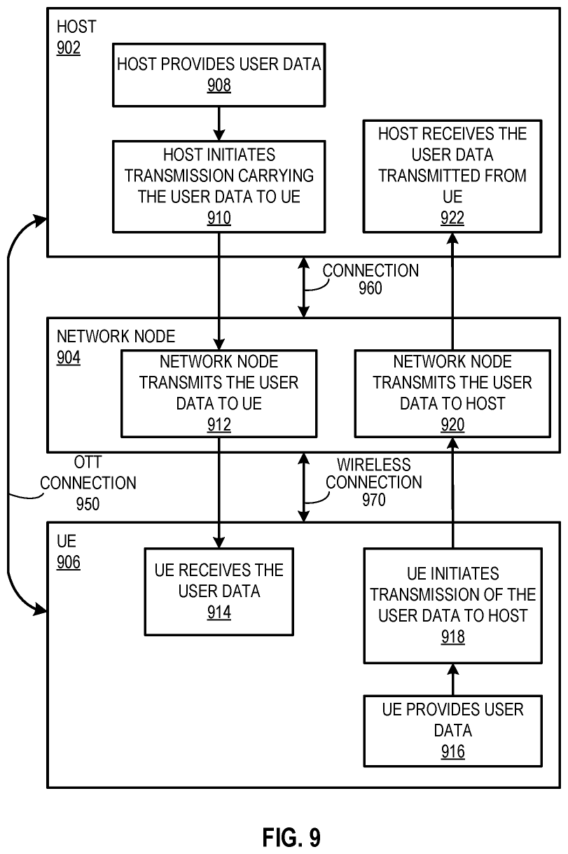

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the OTT connection with respect to data rate, latency, power consumption and thereby provide benefits such as, e.g., reduced user waiting time, relaxed restriction on file size, improved content resolution, better responsiveness, extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In some embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

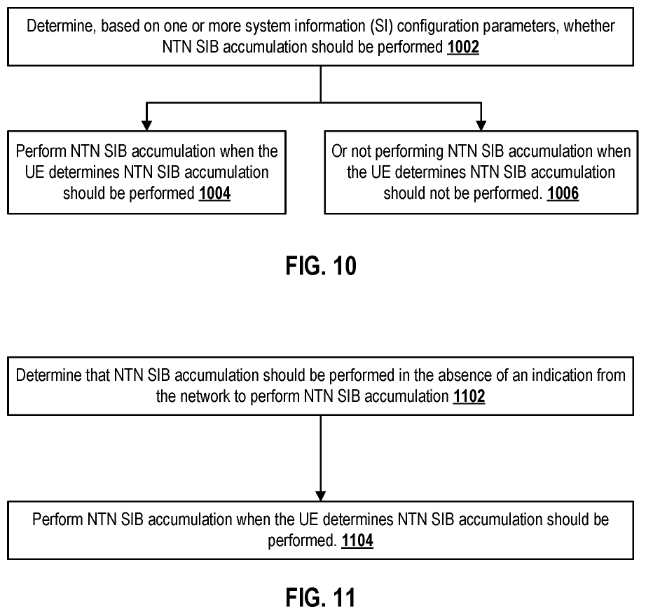

FIG. 10 is a flowchart of a method 1000 for facilitating non-terrestrial network (NTN) system information block (SIB) accumulation. The method 1000 may be performed by a user equipment, such as the UE 500, to facilitate non-terrestrial network (NTN) system information block (SIB) accumulation. The method 1000 may include an operation 1002 of determining, based on one or more system information (SI) configuration parameters, whether NTN SIB accumulation should be performed. The method 1000 may further include an operation 1004 of performing NTN SIB accumulation when the UE determines NTN SIB accumulation should be performed or an operation 1006 of not performing NTN SIB accumulation when the UE determines NTN SIB accumulation should not be performed.

In some embodiments of the method 1000, additional operations may include determining that the network does not explicitly indicate whether NTN SIB accumulation should be performed and thereafter determining, based on one or more SI configuration parameters, whether NTN SIB accumulation should be performed. The one or more SI configuration parameters may include an SI periodicity value. The one or more SI configuration parameters may include an epoch timer indication range and/or a number of SI windows.

The UE 500 may determine whether the network is using explicit or implicit epoch time indication based on one of: an indication in SI other than the NTN SIB; an assumption of explicit epoch time in the absence of an indication of implicit epoch time; an assumption of implicit epoch time in the absence of an indication of explicit epoch time; or an inference based on a parameters signalled in the SI. The one or more parameters may include an validity timer update.

Determining, based on the one or more parameters, may include determining based on the absence or one or more parameters whether NTN SIB accumulation should be performed.

The method 1000, may further include operations of providing user data and forwarding the user data to a host via the transmission to the network node.

FIG. 11 is a flowchart of a method 1100 performable by a user equipment (UE) to facilitate NTN SIB accumulation. The method 1100 may include an operation 1102 of determining that NTN SIB accumulation should be performed in the absence of an indication from the network to perform NTN SIB accumulation and an operation 1104 of performing NTN SIB accumulation when the UE determines NTN SIB accumulation should be performed.

Embodiments of the method 1100 may further include decoding an NTN SIB. Decoding an NTN SIB may include: attempting to decode the NTN SIB; if the attempting to decode the NTN is successful, storing the NTN SIB and receiving and storing an additional NTN SIB in a next SI transmission, and storing the first NTN SIB and receiving and storing the second NTN SIB in the next SI transmission.

The method 1100 may further include attempting to decode the additional NTN SIB without combining the NTN SIB and the additional NTN SIB, or attempting to decode the additional NTN SIB by combining the first stored NTN SIB and the second NTN SIB.

Certain aspects of the disclosure and their embodiments may provide solutions to these noted challenges or other challenges. For example, methods and systems are provided for facilitating NTN SIB prohibition or accumulation in NTN to allow operation in coverage limited condition and to avoid decoding error when NTN SIB contents change frequently.

For example, according to certain embodiments, systems, methods, and signalling are provided to determine if NTN-specific SIB accumulation across SI windows should be allowed in an IoT NTN cell.

As another example, according to certain embodiments, systems, methods, and signalling are provided to support NTN-specific SIB accumulation across SI windows for UEs in an IoT NTN cell

As still another example, according to certain embodiments, systems, methods, and signalling are provided for determining epoch time when NTN-specific SIB accumulation across SI windows is supported.

Certain embodiments may provide one or more of the following technical advantage(s). For example, certain embodiments may provide a technical advantage of facilitating accumulation of NTN-specific SIBs across multiple SI windows for NTN UEs in poor coverage while avoiding decoding errors due to NTN-specific SIB accumulation.

Other advantages may be readily apparent to one having skill in the art. Certain embodiments may have none, some, or all of the recited advantages.

As used herein, SIB accumulation refers to accumulating NTN-specific SIB (which contains satellite ephemeris and/or other assistance information for NTN; and also referred to as NTN SIB) across one or more SI windows.

One or more of the ideas described herein for IoT NTN can also be applied to NR NTN, and/or other scenarios where SIB accumulation is desired for a SIB that changes frequently.

As used herein, “Updating NTN SIB” means that the contents of the NTN SIB are updated.

It may be noted that this disclosure is about NTN SIB accumulation and does not alter the defined UE behavior with regards to accumulation of other legacy SIBs. That is, the UE might as well accumulate other SIBs as done in terrestrial networks.

It may be further noted that there are technically two different NTN SIBs (SystemInformationBlockType31 and SystemInformationBlockType32). The techniques and embodiments disclosed herein can be relevant to both types of NTN SIBs as both may update its ephemeris in between SI windows.

### Prohibiting SIB Accumulation Based on NTN Scenario

According to certain embodiments, SIB accumulation for the NTN SIB is allowed or prohibited depending on how frequently the NTN SIB is updated.

### Example 1

According to certain embodiments, NTN SIB may need to be updated very frequently for LEO as compared to GEO. Therefore, one may need to prohibit SIB accumulation to avoid decoding error if a UE in LEO NTN accumulates SIB across multiple SI windows where the SIB content is different. However, no such prohibition is needed for GEO and the default UE behavior is to accumulate SIB if needed.

In a particular embodiment, it is specified in a standard specification that NTN SIB accumulation for IoT NTN is prohibited for LEO and/or MEO and/or GEO.

In another particular embodiment, the prohibition of the NTN SIB accumulation is indirectly described in terms of the validity timer for uplink synchronization configured by the network. This can be fixed in the specification or the network can indicate it to the UE whether or not it needs to determine NTN SIB prohibition based on the NTN validity timer configuration.

For example, for certain specified validity timer values or if the validity timer value exceeds a certain threshold, then there is no prohibition on SIB accumulation. Otherwise, SIB accumulation is either prohibited or only allowed within a duration less than the validity timer value.

In a further particular embodiment, this prohibition is only applicable if the UE has already acquired a validity timer configuration value i.e., no prohibition on SIB accumulation when the UE is acquiring the NTN SIB for the first time and/or has not acquired a validity timer value.

In still another further particular embodiment, SIB accumulation is prohibited if the UE has not acquired a validity timer configuration value or if it is acquiring NTN SIB for the first time.

In yet another particular embodiment, the network configures if NTN SIB accumulation is prohibited in an NTN cell and broadcasts it using SI.

### Example 2

According to certain embodiments, depending on how frequently the NTN SIB is updated and/or the SI window configuration (e.g., SI window length, SI periodicity, SI repetition pattern), it may be desirable to allow NTN SIB accumulation in certain cells.

In another embodiment, certain rules are defined in the specification which along with broadcast information and/or UE measurement(s), allow the UE to determine if NTN SIB accumulation is prohibited.

In a particular embodiment, for example, SIB accumulation is prohibited for UEs based on UE category and/or coverage enhancement class and/or NTN scenario type (LEO/MEO/GEO).

### Example 3

According to certain embodiments, SIB accumulation is prohibited for NTN UEs in good coverage (when RSRP threshold exceeds a predefined level) when the configured repetitions within the SI window exceed a predefined threshold. Otherwise, it is not prohibited.

### Example 4

According to certain embodiments, SIB accumulation is prohibited if the SI periodicity exceeds the NTN SIB broadcast periodicity, and/or the number of repetitions configured for the SIBs exceed a certain value. The UE may determine these periodicities and repetition pattern from system information, and then determine if it is allowed to accumulate the NTN SIB or not.

In another embodiment, the prohibited SIB accumulation forces the epoch time to not be optional (i.e. it will be mandatorily present in its SIB if SIB accumulation is allowed for this SIB). This is because if epoch time is not signalled, then the epoch time is based on the starting time of the downlink subframe corresponding to the end of the System Information window. So, if SIB accumulation were to happen, there would be confusions regarding where the epoch time should start or not.

In yet another embodiment, the above described ambiguity of the epoch time (when the epoch time is not explicitly indicated but defined by a default rule) caused by repetitions of the concerned SIB (e.g., systemInformationBlockType31) with identical content is alleviated by specifying a rule for when the epoch time is defined in conjunction with SIB repetitions. To this end, it is configured in the SI, e.g., in SIB1, the SIB is transmitted in sets of N identical SIBs (i.e. allowing accumulation), or N SI-windows with identical SIB transmissions (see further section) [0383] and the default epoch time is further configured or specified in relation to a specific one of these SIB transmissions or SI-windows.

For instance, that the default epoch time can be the start time of the downlink subframe corresponding to the end of the first SI-window with identical SIB transmissions.

As another example, that the default epoch time can be the start time of the downlink subframe corresponding to the end of the last SI-window with identical SIB transmissions.

As yet another example, the default epoch time may be the start of the downlink subframe corresponding to the start of a certain SI-window in a set of SI-windows with identical SIB transmissions.

In other examples, the default epoch time is defined as the start of the transmission- or the end of the transmission—of a certain one of the consecutive transmissions of SI messages containing the concerned SIB with unchanged content.

### Supporting SIB Accumulation in NTN Scenario

The following methods pertain to the case where NTN SIB accumulation is supported in an NTN cell.

In a particular embodiment, once the UE has determined that NTN SIB accumulation is not prohibited, it is left up to the UE implementation to determine the number of SI windows across which NTN SIBs can be accumulated. For example, the UE may opportunistically attempt to decode the NTN SIB by accumulating across SI windows on a trial-and-error basis. It may also use orbit prediction algorithms or other side information such as uplink synchronization validity timer values or previously acquired satellite ephemeris/common TA parameters to estimate how frequently the satellite ephemeris/common TA etc. will be updated by the network. Then, it can attempt to accumulate the NTN SIB in SI windows which fall within its estimated duration during which the NTN SIB content is expected to remain unchanged.

In a particular embodiment, once the UE has determined that NTN SIB accumulation is not prohibited, it is the number of SI windows across which NTN SIBs can be accumulated is specified in the standard specification.

In another particular embodiment, the network indicates it to the UE the number of SI windows it can accumulate across.

In a particular embodiment, a set of NTN specific SI window lengths is specified. It includes the existing SI window lengths, e.g., {160, 320, 480, 960, 1280, 1600} ms for NB-IoT, and adds to that additional lengths such as 3200 and 6400 ms. Similarly, as another example, the existing SI window length for LTE-M {1, 2, 5, 10, 15, 20, 40, 60, 80, 120, 160, 200} ms can also be expanded to include additional lengths such as 240, 280, 320 and 360 ms. With a longer SI window, the network may configure a larger number of repetitions of the NTN SIB within an SI window. It may eliminate the need to accumulate NTN SIB across multiple SI windows, or reduce the number of SI windows that the UE needs to accumulate across in order to correctly decode the NTN SIB.

In a particular embodiment, the new SI window lengths are applicable to all SI windows in NTN. Alternatively, it only applies to the SI window containing the NTN SIBs and information about which SI window contains the SI message with NTN SIB can be either specified or indicated to the UE in SI.

In a particular embodiment, the existing values in the set for configuring a SI window length are fully or partially re-interpreted as different values for IoT NTN scenarios.

In a particular embodiment, the values in the set for configuring a SI window length can be different depending on the satellite orbit altitude (e.g., the set of values is different for LEO and GEO satellite orbits).

In a particular embodiment, the existing values in the set for configuring the “si-Periodicity” are either fully re-used or new values are added (e.g., longer values are appended) to it for IoT NTN scenarios.

In a particular embodiment, the existing values in the set for configuring the “si-Periodicity” are fully or partially re-interpreted as different values for IoT NTN scenarios.

In a particular embodiment, the values in the set for configuring the “si-Periodicity” can be different depending on the satellite orbit altitude (e.g., the set of values is different for LEO and GEO satellite orbits).

In a particular embodiment, the existing values in the set for configuring the “si-RadioFrameOffset” are either fully re-used or new values are added (e.g., longer values are appended) to it for IoT NTN scenarios.

In a particular embodiment, the existing values in the set for configuring the “si-RadioFrameOffset” are fully or partially re-interpreted as different values for IoT NTN scenarios.

In a particular embodiment, the values in the set for configuring the “si-RadioFrameOffset” can be different depending on the satellite orbit altitude (e.g., the set of values is different for LEO and GEO satellite orbits).

In a particular embodiment, the existing values in the set for configuring the “si-RepetitionPattern” are either fully re-used or new values are added (e.g., longer values are appended) to it for IoT NTN scenarios.

In a particular embodiment, the existing values in the set for configuring the “si-RepetitionPattern” are fully or partially re-interpreted as different values for IoT NTN scenarios.

In a particular embodiment, the values in the set for configuring the “si-RepetitionPattern” can be different depending on the satellite orbit altitude (e.g., the set of values is different for LEO and GEO satellite orbits).

Similarly, in some embodiments, if SIB accumulation is supported in NTN scenario, the epoch time becomes mandatorily present.

Details for Network Indication of NTN SIB Accumulation and/or Assistance Information

According to certain embodiments, the network uses one or more of the following methods to indicate one or more of the aforementioned information to the UEs in an NTN cell.

In particular embodiments, the network may indicate 1-bit information about SIB accumulation prohibition using
MIB
SIB other than the NTN SIB, e.g., in SIB1, e.g., in the SI scheduling information

Different SI-RNTI is defined and specified to indicate NTN SIB accumulation is allowed in addition to the existing SI-RNTI. This enables selectively allowing accumulation per SI message (and thus SIB selective) and may also be dynamically changed between SI message transmissions and SI-windows.

In another particular embodiment, the SIB accumulation targets a specific NTN SIB, which is either the NTN SIB needed for uplink synchronization (SystemInformationBlockType31) or the NTN SIB used for discontinuous coverage (SystemInformationBlockType32). This can be specified and/or additionally indicated to the UE. Alternatively, SIB accumulation information is applicable to both NTN SIBs.

### Further Embodiments on Configuration of SIB Accumulation in IoT NTN

As previously described, the number of repeated SIB transmissions (of a certain SIB, e.g., an NTN SIB such as systemInformationBlockType31 or systemInformationBlockType32) can be configured and signaled in another SIB, preferably a SIB in which the content is static, or semi-static, so that the UE can apply SIB accumulation for that SIB without restrictions.

The indication would first of all consist of an indication of the number, N, of consecutive SIB transmission without update of the content (i.e. the number of identical repeated SIB transmissions). The transmissions of the concerned SIB will thus be transmitted in repeated sets of N identical transmissions (i.e. with unchanged content). There would hence be a set of N transmissions of the unchanged SIB, followed by another set of N identical SIB transmissions, where updates of the SIB content can only occur between two sets.

To allow a UE to a priori identify the start of a set of N identical SIB transmissions, a reference is needed. This reference could be specified and a natural definition could be that the first transmission of a set of identical SIB transmissions occurs in the first SI-window (containing an SI message with the concerned SIB) starting at or after SFN=0. The N identical transmissions would be followed by a potentially updated transmission, which marks the first transmission of another set of N identical SIB transmissions.

A disadvantage of using SFN=0 as the reference is that this would be somewhat restrictive, since it forces an update (or at least that the UE has to assume that there is an update) of the SIB every SFN cycle wrap-around (which occurs after 1024 SFNs). This would exclude repetition across SI-windows when the SI-window periodicity is 4096, 2048 or 1024 frames, and would allow accumulation of only two SI-window transmissions when the SI-window periodicity is 512 frames. If Hyper-SFNs are considered for IoT-NTN, this is easily solved by making the start of H-SFN=0 the reference instead of SFN=0. Otherwise, an unambiguous reference that does not restrict the repetition and accumulation possibilities can be realized by combining SFN=0 with a UTC as the reference, e.g., the occurrence of SFN=0 that is the closest to UTC=xxxxx. This can still be specified, since the UTC “xxxxx” could also be specified, as long as “xxxxx” is a time that occurred in the past, e.g., the start of the UTC time-keeping.

The above describes the configuration parameter N as indicating the number of consecutive identical transmissions of the concerned SIB. In an alternative embodiment, the configuration parameter N instead indicates the number of SI-windows (in which the SI message containing the concerned SIB is transmitted) the concerned SIB will be unchanged. This means that repetitions within an SI-window and the number of SI-windows indicated by N are multiplied to give the number of consecutive transmissions of the concerned SIB with unchanged content. For example, if the concerned SIB is transmitted twice within each SI-window (in which the SI message containing the concerned SIB is transmitted) and the SIB remains unchanged for N=2 such SI-windows, the number of identical SIB transmissions is 2×2=4.

In a particular embodiment, N is not indicated in the SI but is specified in a standard specification. In such a case, different N values may be specified for different network deployment scenarios, e.g., for LEO, MEO, GEO and HAPS/HIBS deployments.

In another particular embodiment, N is configured in the USIM, e.g., when the USIM (e.g., on a SIM card) is provisioned, or configured in the USIM using Over-The-Air (OTA) configuration.

In a particular embodiment, the reference for the start of a set of N identical SIB transmission or a set of N SI-windows (in which the SI message containing the concerned SIB is transmitted) the concerned SIB will be unchanged, is configured in the system information, e.g., in SIB1.

In another particular embodiment, the network does not necessarily need to send a different SIB after “N” identical transmissions. In practice, it may send the same SIB in the next “N” transmissions but as far as the UE behavior is concerned, UE will assume that SIB content can be potentially different after the “N” transmissions and that it should refrain from accumulating SIBs other than the indicated “N” transmissions.

### REFERENCES

1. TR 38.811, Study on New Radio (NR) to support non-terrestrial networks
2. TR 38.821, Solutions for NR to support non-terrestrial networks, 3GPP, 16.1.0, June 2021.
3. RP-193234, Solutions for NR to support non-terrestrial networks (NTN), 3GPP RAN #86
4. RP-193235, Study on NB-Io/eMTC support for Non-Terrestrial Network, 3GPP RAN #86
5. RP-202689, Study on NB-IoT/eMTC support for Non-terrestrial Network, RAN #90, December 2020.
6. RP-211601, NB-IoT/eMTC support for Non-terrestrial Networks (NTN), RAN #92-e, June 2021.
7. TR 36.763, Study on Narrow-Band Internet of Things (NB-IoT)/enhanced Machine Type Communication (eMTC) support for Non-Terrestrial Networks (NTN), 3GPP, 17.0.0, June 2021.
8. R2-2203810, Support of Non-Terrestrial Network in NB-IoT and eMTC, 3GPP RAN2 #117-e

1. A method performed by a user equipment (UE) for to facilitate non-terrestrial network (NTN) system information block (SIB) accumulation, the method comprising:
determining, based on one or more system information (SI) configuration parameters, whether NTN SIB accumulation should be performed; and
performing NTN SIB accumulation when the UE determines NTN SIB accumulation should be performed; or
not performing NTN SIB accumulation when the UE determines NTN SIB accumulation should not be performed.

2. The method of claim 1, further comprising the step of:
determining that the network does not explicitly indicate whether NTN SIB accumulation should be performed;
thereafter determining, based on one or more SI configuration parameters, whether NTN SIB accumulation should be performed.

3. The method of claim 1, wherein the one or more SI configuration parameters comprises an SI periodicity value.

4. The method of claim 1, wherein the one or more SI configuration parameters comprises an epoch timer indication range and/or a number of SI windows.

5. The method of claim 1, wherein the UE determines whether the network is using explicit or implicit epoch time indication based on one of:
an indication in SI other than the NTN SIB;
an assumption of explicit epoch time in the absence of an indication of implicit epoch time;
an assumption of implicit epoch time in the absence of an indication of explicit epoch time; or
an inference based on a parameters signalled in the SI.

6. The method of claim 1, wherein the one or more parameters includes a validity timer update.

7. The method of claim 1, wherein determining, based on the one or more parameters, comprises determining based on the absence or one or more parameters whether NTN SIB accumulation should be performed.

8. The method of claim 1, further comprising:
providing user data; and
forwarding the user data to a host via the transmission to the network node.

9. A method performed by a user equipment (UE) for to facilitate NTN SIB accumulation, the method comprising:
determining that NTN SIB accumulation should be performed in the absence of an indication from the network to perform NTN SIB accumulation; and
performing NTN SIB accumulation when the UE determines NTN SIB accumulation should be performed.

10. The method of claim 9, further comprising decoding an NTN SIB.

11. The method of claim 10, wherein decoding an NTN SIB comprises:
attempting to decode the NTN SIB;
if the attempting to decode the NTN is successful, storing the NTN SIB and receiving and storing an additional NTN SIB in a next SI transmission and;
storing the first NTN SIB and receiving and storing the second NTN SIB in the next SI transmission.

12. The method of claim 11, further comprising:
attempting to decode the additional NTN SIB without combining the NTN SIB and the additional NTN SIB; or
attempting to decode the additional NTN SIB by combining the first stored NTN SIB and the second NTN SIB.

13. A user equipment for facilitating NTN SIB accumulation in NTN to allow operation in coverage limited condition and to avoid decoding error when NTN SIB contents change frequently for either or both implicit and explicit epoch time indication, comprising:
processing circuitry configured to perform
operations comprising:
determining, based on one or more system information (SI) configuration parameters, whether NTN SIB accumulation should be performed; and
performing NTN SIB accumulation when the UE determines NTN SIB accumulation should be performed; or
not performing NTN SIB accumulation when the UE determines NTN SIB accumulation should not be performed.

14-30. (canceled)

31. The user equipment of claim 13, wherein, the operations further comprise:
determining that the network does not explicitly indicate whether NTN SIB accumulation should be performed;
thereafter determining, based on one or more SI configuration parameters, whether NTN SIB accumulation should be performed.

32. The user equipment of claim 13, wherein the one or more SI configuration parameters comprises an SI periodicity value.

33. The user equipment of claim 13, wherein the one or more SI configuration parameters comprises an epoch timer indication range and/or a number of SI windows.

34. The user equipment of claim 13, wherein the UE determines whether the network is using explicit or implicit epoch time indication based on one of:
an indication in SI other than the NTN SIB;
an assumption of explicit epoch time in the absence of an indication of implicit epoch time;
an assumption of implicit epoch time in the absence of an indication of explicit epoch time; or
an inference based on a parameters signalled in the SI.

35. The user equipment of claim 13, wherein the one or more parameters includes a validity timer update.

36. The user equipment of claim 13, wherein determining, based on the one or more parameters, comprises determining based on the absence or one or more parameters whether NTN SIB accumulation should be performed.

37. The user equipment of claim 13, wherein the operations further comprise:
decoding an NTN SIB, wherein decoding an NTN SIB comprises:
attempting to decode the NTN SIB;
if the attempting to decode the NTN is successful, storing the NTN SIB and receiving and storing an additional NTN SIB in a next SI transmission.
